(19) United States
(12) Patent Application Publication
(10) Pub. No.: US 2003/0054085 A1
(43) Pub. Date: Mar. 20, 2003

(54) Complete animal feed with potato component

(76) Inventor: Tom Anderson, Pocatelo, ID (US)

Correspondence Address: PEDERSEN & COMPANY, PLLC, P.O. BOX 2666, BOISE, ID, 83701, US

(21) Appl. No.: 10/246,010

(22) Filed: Sep. 17, 2002

Related U.S. Application Data
(63) Continuation-in-part of application No. 09/579,021, filed on May 25, 2000, now Pat. No. 6,451,370.

(51) Int. Cl. A23K 1/00

(52) U.S. Cl. 426/635

(57) ABSTRACT

A complete integral pelletized animal feed which is easily and economically prepared with a potato component. This invention combines hay, oats, and potato waste with a primary and secondary supplement premix. The potato component acts as a binder which makes it possible to pelletize the combined components. The composite animal feed is a complete food requiring no further supplementation. The instant invention provides an economical, one-step, integral, composite animal feed which incorporates potato waste and a primary and secondary supplement premix forming a complete animal feed. The instant invention is economically produced using potato waste, and economical to use since no further supplementation is necessary. Further, the complete feed with primary and secondary supplements has the capacity to improve performance characteristics in, for example race or show horses, far beyond what might be expected if the individual components were singly incorporated into the animal's diet.

This application is a continuation in part application of, and claims priority from, U.S. patent application Ser. No. 09/579,021, filed on May 25, 2000, entitled “Complete Animal Feed with Potato Component” the disclosure of which is incorporated herein by this reference.

### BACKGROUND OF THE INVENTION

1. Field of the Invention

This invention relates generally to food for animals. More specifically, this invention relates to a complete, integral animal feed, especially for horses, cattle, dogs, cats and other domesticated animals. The complete animal feed includes a potato component which acts as a binder to bind all of the components of the feed into an integral, pelletizable product. The potato component is particularly useful for binding a nutritional supplement package comprising a primary and secondary supplement with the other components. The nutritional supplements may vary depending upon the animal in question and the activity level of the subject animal. All of the components, including the nutritional supplements, are combined and then the entire mixture is pelletized in one step. The resulting pellets provide an integral animal feed which alone meets the complete nutritional requirements of the particular animal.

2. Related Art

For a long time, ranchers and cattle feed-lot operators have fed cows with feed with a potato component. Typically, the potato component is a by-product from potato processing for food for humans. For example, potato peels, off-size bits and chunks, and off-spec potato flakes or granules, french fries and hash browns have often been recovered and used for cattle feed.

Typically, however, the potato component in cattle feed has been just a portion of the cow's diet. Supplemental roughage and nutrients from hay and grain have also been required. These supplemental components have been supplied separately to the ranch pens and commercial feedlots where they have been typically mixed with the potato component and distributed to the cattle feed bunks and troughs.

U.S. Pat. No. 5,051,270 (Ueda et al.) discloses a high protein food containing potato powder, the food product being prepared by forming a dough, and heating the dough in a vacuum until the dough is dried to a water content of about 3 weight percent. It is critical that the product be heated at reduced pressure to obtain the desired water content without heating the dough itself excessively, permitting the proteins to be thermally denatured and thereby give an improved flavor without becoming thermally degraded. The process of Ueda produces a food which does not feel powdery, but tastes more like snack foods.

U.S. Pat. No. 5,354,818 (Vazza) discloses a livestock feed from potato waste which is treated with a starch hydrolyzing enzyme and three types of yeasts. The starch hydrolyzing enzyme aids in the conversion of the starch present in the potato waste to sugars which the fermenting yeasts utilize during their growth. The particular combination and order of addition of yeasts and enzymes insures that virtually all carbohydrate present in the potato waste is used to support the growth of the yeasts producing a high protein, low carbohydrate livestock feed.

Still, there is a need for a complete integral animal feed which is easily and economically prepared with a potato component. This invention addresses that need by combining hay, oats, and potato waste with a primary and secondary nutritional supplement premix. The composite animal feed is economical for use because it is a complete food requiring no further supplementation. Further, the instant invention provides an economical, one-step, integral, method of producing the composite animal feed which incorporates potato waste and a primary and secondary supplement premix forming a complete animal feed.

### SUMMARY OF THE INVENTION

The invention is an animal feed containing a potato component, a method of producing an animal feed containing a potato component, and a means of enhancing, beyond reasonable expectations, this animal feed through nutritional supplementation. Preferably, the potato component is a dehydrated potato flake component which is a by-product of potato flake manufacture for human consumption, and contains only about 10 weight percent water. In addition, when used as a horse feed, the composite also contains chopped or ground hay, ground oats and a primary soy-meal based supplement containing a yeast culture, vitamins, minerals and 50 weight percent soy-meal. The relative weight percent of each of the components is about:

40 wt %—hay

20 wt %—oats

35 wt %—potato flakes

5 wt %—primary supplement

Total—100%

To enhance, for example, race or show horse performance beyond reasonable expectations a secondary supplement which comprises glucosamine, chondroitin, and yucca extract is added to the feed composition. All of these components are mixed together in a large batch mixing device and the whole mixture is then pelletized to create individual, integral briquettes, sized about 1 cubic inch and bagged in 50 lb. packages for a complete horse feed.

When the feed is used for other animals, the relative weight percentages of the components, the components themselves, and the composition of the supplement may vary. However, in all instances, the potato component acts as the binder. The binder makes it possible to produce an integral pelletized food, including nutritional supplements, which meets all of the nutritional requirements of the particular animal in question.

### DESCRIPTION OF THE PREFERRED EMBODIMENTS

The invention is a simple, complete animal feed containing a potato component, hay, and oats, with a primary supplement premix and a secondary supplement premix; and a method of producing said animal feed. Preferably, the potato component is processed from potato waste from potato processing plants producing potato flakes, granules, french fries, potato chips and the like. More preferably, the potato component is a dehydrated potato flake component which is a by-product of potato flake manufacture for human consumption, and contains only about 10 weight percent water, or less.

When used as a horse feed, for example, along with the potato component, the composite also contains the following components: chopped or ground hay, ground oats, and primary and secondary nutritional supplements. The hay is preferably ground alfalfa, although timothy, clover or other dried grasses may be suitable. The alfalfa is used in an amount sufficient to make up about 40 weight percent of the final feed product. The ground oats make up about 20 weight percent of the final product.

The primary nutritional supplement is preferably a soy-meal based supplement containing soybean meal, yeast culture, selenium (0.14 mg/lb. final product) or (0.3 ppm)??, mono-dicalcium phosphate, wheat midds, calcium carbonate (about 5 wt. %), salt (about 5 wt. %), magnesium oxide, lysine, methionine, vitamin A acetate (25,000 IU/lb), vitamin D₃ supplement (10,000 IU/lb), vitamin E supplement (300 IU/lb), choline chloride, biotin, cobalt glucoheptonate, copper amino acid complex, copper sulfate, ethylene diamine dihydriodide (EDDI), iron carbonate, manganese amino acid complex, manganese sulfate, sodium selenite, zinc amino acid complex, zinc sulfate, mineral oil, and natural and artificial flavors. More preferably, the primary nutritional supplement is comprised of a soy-meal base and quantities of Equi-Life “Plus”™ vitamin and mineral complex, available from NutraHealth, Inc. and Yea Sacc Yeast™, available from Alltech, Inc. of Nicholasville, Ky.

A secondary supplement may be added to the complete feed mixture to augment the performance characteristics of, for example, race or show horses. This additional supplement offers owners of such animals an economical means of enhancing performance well beyond the foreseeable consequence of including each of the individual components in the animal's diet. The secondary supplement preferably contains quantities of glucosamine and chondroitin. Additionally, though unnecessary for supplementation purposes, yucca extract may be included in the secondary supplement. These components may be combined to form an integral secondary supplement and then added to the final product according to the following ratios:

2500 mg glucosamine/10 lbs. product

750 mg chondroitin/10 lbs. product

3250 mg yucca extract/10 lbs. product

Most preferably, the secondary supplement comprises a quantity of Sierra Gold Biomax™ “Plus”, available from Sierra Ranch Supply of Twin Falls, Id. sufficient to achieve the above ratios.

The relative weight percent of each of the components in the preferred horse feed, without secondary supplementation, is about:

40 wt %—alfalfa

20 wt %—oats

35 wt %—potato flakes

5 wt %—primary supplement

Total—100%

The relative weight percent of the secondary supplement if added in an amount necessary to achieve the preferred quantities of glucosamine, chondroitin, and yucca extract above is typically less than 1 percent of the total mixture. For example, preferably about 3.25 fluid ounces of Sierra Gold Biomax™ “Plus” is added to a 50 lb. mixture of complete feed prior to pelletization for a very active horse. Consequently, addition of the secondary supplement will change these percentages slightly, but not significantly.

All of these components, as well as the secondary supplement, are mixed together in a large homogenizer and the complete mixture is then pelletized to create individual, integral briquettes, sized about 1 cubic inch and bagged in 50 lb. packages for a complete horse feed.

The pelletization process is carried out using the following four basic steps:

1. Double grinding. The primary grinder, a W. H. U. tub grinder, accepts the various components in the proper weight percentages and completes the initial grind by forcing the components through a 1/2″ screen by way of a rotary hammer mill. The product is then augered into a second hammer mill and forced through a 1/4″ screen. Pneumatics then lift the ground product into an overhead surge bin.

2. Making the pellet. In the second step, the ground product is augered from the surge bin directly into a pellet mill where steam is added in a mixing chamber to create a damp meal-like substance. This “meal” then enters a pellet chamber where metal rolls force the meal into holes in a pellet die. As the die fills, meal continues to be pushed into the holes until it is forced out the other side of the die, creating a pellet.

3. Cooling. In the cooling process, the hot pellet is dropped directly out of the mill into a cooling chamber. The pellets are in a continuous flow through the 8′ cooling chamber where ambient air is forced over the pellets to extract any additional heat and moisture. Cooled pellets are then transferred from the cooling chamber to overhead storage bins by way of an elevator leg.

4. Load out. The final step is to load-out the finished product from overhead storage bins into trucks below using gravity flow.

The above delineated pelletizing process is the same process used for making the various types of animal feed contemplated by the instant invention. When the feed is used for dog or cat food, for instance, the potato component and the hay and oat components will remain about the same. However, in these instances, the primary and secondary supplement components will change.

The particular components of each of the embodiments of the instant invention will vary depending upon the particular nutritional requirements of the animal in question. In each case, however, once the components are determined, the pelletization process is largely identical. The novel aspect of the instant invention is the inclusion of a potato component which acts as a binder allowing the formation of pelletized animal food containing all of the desired components.

It is known to use potato waste as food for animals. Potato waste from plants producing sweet potatoes, potato flakes, granules, french fries or potato chips, may include the waste slurry from steam or abrasive peelers, potato trimmings from inspection tables, improperly blanched potatoes, finished potatoes which are damaged due to dehydration, and undersized potatoes that do not meet processing standards. It has been found that potato waste slurry is not useful for producing the animal feed of the instant invention. In order to produce a composite product which is pelletizable, the potato component is processed from potato waste from potato processing plants producing potato flakes, granules, french fries, potato chips and the like. More preferably, the potato component is a dehydrated potato flake component which is a by-product of potato flake manufacture for human consumption, and contains only about 10 weight percent water, or less. It has been found that dehydrated potato flakes containing about 10 weight percent water, or less, allows for facile pelletization of the final composite material containing each of the desired components.

The starch from the potato component acts to bind all of the components of the final animal feed product into a pelletizable composite. It is believed that the process for producing potato flakes or granules for human consumption causes rupture of potato cells so that starch is released from the cells. The product resulting from said process is thereby well suited to act as a binder in the instant invention. It is also important to use dehydrated potato flakes or granules containing 10 weight percent water or less. It has been found that a higher water weight percentage prevents the formation of high quality pellets of the final composite material. While other potato waste products likely contain ruptured cells due to processing, the amount of rupturing, and therefore available starch, is not of an amount sufficient to facilitate adequate binding to produce a final pelletizable product.

In compliance with the statute, the invention has been described above with reference to particular means, materials and embodiments. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A pelletized, complete animal feed made from potato waste comprising:
at least one digestible food product selected from the group consisting of hay and oats;
a primary nutritional supplement comprising: a yeast culture, selenium, vitamins, and up to about 50 weight percent soy-meal;
a secondary nutritional supplement selected from the group consisting of: glucosamine, chondroitin, and yucca extract; and
a potato waste component;
wherein said potato waste component acts as a binder to bind together said food product, primary nutritional supplement, secondary nutritional supplement and potato waste component into a pelletizable animal food.

2. The animal feed of claim 1 wherein:
said potato waste component comprises dehydrated potato flakes or granules.

3. The animal feed of claim 1 wherein:
said potato waste component contains only about 10 weight percent water, or less.

4. The animal feed of claim 1 wherein:
said potato waste component comprises dehydrated potato flakes or granules which contain only about 10 weight percent water, or less.

5. The animal feed of claim 1 wherein:
said animal feed is a horse feed.

6. The animal feed of claim 5 wherein:
said potato waste component comprises dehydrated potato flakes or granules.

7. The animal feed of claim 5 wherein:
said potato waste component contains only about 10 weight percent water, or less.

8. The animal feed of claim 5 wherein:
said potato waste component comprises dehydrated potato flakes or granules which contain only about 10 weight percent water, or less.

9. The animal feed of claim 8 wherein:
said digestible food product comprises about 67 wt. % hay and about 33 wt. % oats.

10. The animal feed of claim 9 wherein:
said primary nutritional supplement comprises a yeast culture, selenium, vitamins, minerals and about 50 wt. % soy-meal.

11. The animal feed of claim 10 wherein:
said secondary nutritional supplement comprises glucosamine, chondroitin, and yucca extract.

12. The animal feed of claim 11 wherein:
said animal feed comprises about 40 wt. % hay, 20 wt. % oats, 35 wt. % potato waste, and 5 wt. % nutritional supplements.

13. A method of making an animal feed from potato waste comprising:
providing:
at least one digestible food product selected from the group consisting of hay and oats;
a primary nutritional supplement comprising: a yeast culture, selenium, vitamins, and up to about 50 percent soy-meal;
a secondary nutritional supplement selected from the group consisting of:
glucosamine,
chondroitin, and yucca extract; and
a potato waste component;
combining said food product, said nutritional supplements, and said potato waste component in a grinder;
grinding said food product, said nutritional supplements, and said potato waste component in said grinder to form a ground product;
conveying said ground product into a mixing chamber;
adding steam to said ground product in said mixing chamber to form a meal;
conveying said meal to a pellet chamber where metal rolls force the meal into holes in a pellet die;
forcing the meal through the pellet die to form pellets; and
allowing the pellets to cool.

14. The method of claim 13 wherein:
said potato waste component comprises dehydrated potato flakes or granules.

15. The method of claim 13 wherein:
said potato waste component contains only about 10 weight percent water, or less.

16. The method of claim 13 wherein:
said potato waste component comprises dehydrated potato flakes or granules which contain only about 10 weight percent water, or less.

17. The method of claim 16 wherein:
said animal feed is a horse feed.

18. The method of claim 17 wherein:
said digestible food product comprises about 67 wt. % hay and about 33 wt. % oats.

19. The method of claim 18 wherein:
said primary nutritional supplement comprises a yeast culture, selenium, vitamins, minerals and about 50 wt. % soy-meal.

20. The method of claim 19 wherein:
said secondary nutritional supplement comprises glucosamine, chondroitin, and yucca extract.

21. The method of claim 20 wherein:
said animal feed comprises about 40 wt. % hay, 20 wt. % oats, 35 wt. % potato waste, and 5 wt. % nutritional supplements.
